(19) United States
(12) Patent Application Publication
(10) Pub. No.: US 2008/0123734 A1
(43) Pub. Date: May 29, 2008

(54) VIDEO GENERATION SYSTEM AND METHOD

(75) Inventors: SAN-WEI LIN, YILAN COUNTY (TW); PENG-WEI CHEN, TAIPEI COUNTY (TW); CHEN-HSIU WENG, TAIPEI COUNTY (TW); YON-FON KUO, TAICHUNG CITY (TW); TSAI-YEN LI, TAIPEI CITY (TW); WEN-HUNG LIAO, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: IMAGETECH CO., LTD., TAIPEI (TW)

(21) Appl. No.: 11/773,565

(22) Filed: Jul. 5, 2007

(30) Foreign Application Priority Data
Jul. 10, 2006 (TW) 095124995

(51) Int. Cl. H04N 11/02

(52) U.S. Cl. 375/240.01; 375/E07.076

(57) ABSTRACT

A video generation system and method is disclosed. The system includes a network, a camera device and a server. The camera device is for capturing an original video. The original video is transmitted by the network to the server. The server has a feature recognition unit, a medium object modification unit and a video synthesis unit. The feature recognition unit is for recognizing and positioning feature information of the original video. The medium object modification unit is for modifying a medium object based on the feature information to generate a modified medium object. The video synthesis unit is for synthesizing the original video and the modified medium object to generate a synthesized video based on the feature information.

### BACKGROUND OF THE INVENTION

(a) Field of the Invention

The present invention is related to a video generation system and method, and more particularly, to one that executes synthesis of an original video and a medium object at a remote server.

(b) Description of the Prior Art

As digital cameras, network videos, and camera on cell phones are getting more popular, consumers demand more on video multi-media. Consumers are no longer satisfying with taking photos and recording images with a portable image device, they further expect to incorporate those images or videos with special effects as seen on TV or video games to promote entertaining interest. However, data process speed of the portable video device is slower than that of a desktop or a notebook, and thus requires longer time to process video and audio data. A user may run into serious problem if he/she attempts to process information containing massive multimedia operation with the portable video device.

With comprehensive application of Internet and wireless local area network (WLAN) today, the portable video device is usually provided with the function of data transmission through the network that gives the user to take advantage of a remote server with more powerful operation capability to perform complicated data process and then transmit the processed data back to the portable video device.

### SUMMARY OF THE INVENTION

The primary purpose of the present invention is to provide a video generation system and method by having a remote server to execute synthesis of an original video and a medium object to solve the problem of poor multimedia data process capability by the portable video device.

To achieve the purpose, the video generation system of the present invention includes a network, a camera device, and a server. The camera device captures an original video and then transmits it to the server through the network. The server is provided with a feature recognition unit, a medium object modification unit, and a video synthesis unit. The feature recognition unit recognizes and positions feature information of the original video; the medium object modification unit modifies a medium object based on the feature information to generate a modified medium object; and the video synthesis unit synthesizes the original video and the modified medium object to generate a synthesized video based on the feature information.

Furthermore, the present invention discloses a method to generate video involving the following steps. Firstly, an original video is provided and transmitted to a remote server through a network for the remote server to recognize and position a feature information of the original video; based on the feature information, the remote server modifies a medium object to generate a modified medium object; and finally the remote server synthesizes the original video and the modified to produce a synthesized video based on the feature information.

### BRIEF DESCRIPTION OF THE DRAWINGS

FIG. 1 is a schematic view showing a video generation system of the present invention.

FIG. 2 is a schematic view showing a preferred embodiment of the video generation system of the present invention.

FIG. 3 is a process flow chart of a video generation method of the present invention.

FIG. 4 is a process flow chart of a preferred embodiment of the video generation method of the present invention.

### DETAILED DESCRIPTION OF THE PREFERRED EMBODIMENTS

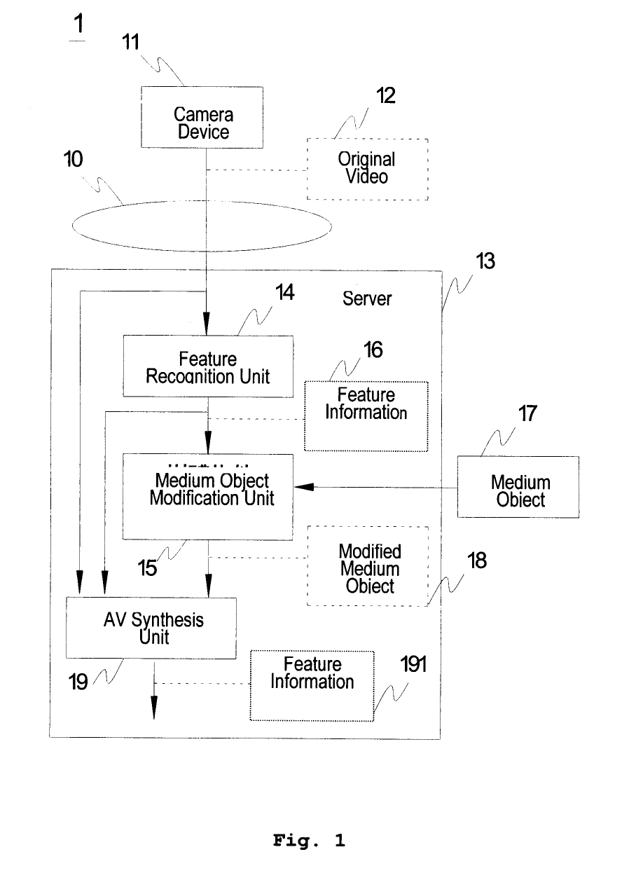

Referring to FIG. 1 for a schematic view of a video generation system of the present invention, the video generation system 1 includes a network 10, a camera device 11, and a server 13. The camera device 11 captures an original video 12 and transmits the original video 12 to the server 13 via the network 10. The server 13 includes a feature recognition unit 14, a medium object modification unit 15, and a video synthesis unit 19. The feature recognition unit 14 recognizes and positions feature information 16 of the original video 12; the medium object modification unit 15 modifies a medium object 17 based on the feature information 16 to generate a modified medium object 18; and the video synthesis unit 19 synthesizes the original video 12 and the modified medium object 18 based on the feature information 16 to produce a synthesized video 191. The synthesized video 191 is then stored in a storage device of the server 13 or transmitted through the network back to an electronic device adapted with the camera device 11 to replay, or stored through the network in a preset remote storage device.

The original video 12 may be related to AV (audio and video) data or a still image. The original video 12 is preferred containing portrait image data. The feature information 16 is related to any combination of features of positions of a facial feature, features and locations of hairs, features and locations of fingers, and postures of trunk and extremities of the image information of the portrait. The medium object 17 is preferred a 2D (dimensional) model, a 3D model, audio data or any combination among them, e.g., virtual portrait, virtual idol of god, cartoon figure or situation music, etc. Each medium object may contain multiple modification parameters, e.g., any combination of 2D and 3D models provided with parameters of facial expressions, parameters of ratios of facial features, parameters of hair ratios, parameters of figure motions, parameters of finger ratios, parameters of motions of human trunk and extremities, and parameters of ratios of human trunk and extremities while the audio information contains parameters of human expressions responding to a situation music. Accordingly, the medium-object modification unit 15 changes motions of the portrait or the situation music depending on the human face or body features in the original video 12. While transmitting the original video 12 to the server 13, a user may manually preset a topic, e.g., happy birthday, wedding ceremony or graduation ceremony for the medium object 17 to utilize virtual portrait model and music readily available in the database.

The user may decide a topic for the medium object 17 based on the feature information 16. For example, if the facial image of the original video 12 is determined as a sad expression (with dropping corners of mouth) according to the feature information 16, the virtual portrait is modified to look sad while the situation music is change to a sad one; alternatively, when the trunk and extremities of the figure in the original video 12 is determined as that imitating the Superman according to the feature information 16, the music is changed to a background music of the Superman; or if the fingers in the image is determined as making a sign of victory according to the feature information 16, V, then the music is changed to one that exclaims joy.

Wherein, the camera device 11 is adapted to a portable electronic device, e.g., a cell phone, notebook, PDA (personal digital assistant) or a digital camera. The network 10 is preferably an Internet or Wireless LAN. The original video 12 may be transmitted in a file format or a streaming format. The medium object 17 is stored in a database built in the server 13 or a remote database.

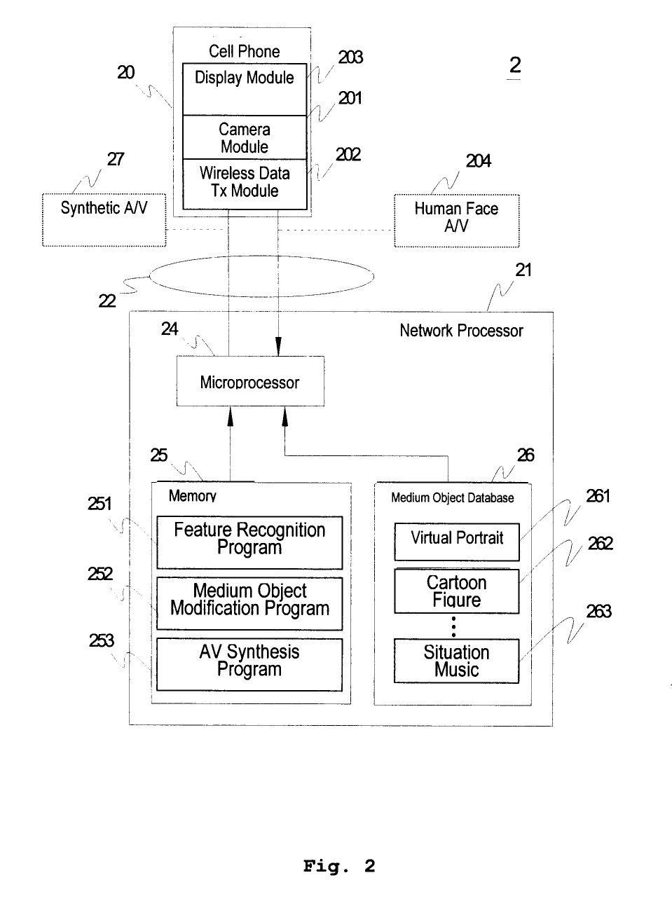

Now referring to FIG. 2 for a schematic view of a preferred embodiment of the video generation system of the present invention, a video generation system 2 includes a cell phone 20, a network server 21, and a wireless network 22. The cell phone 20 is provided with a camera module 201, a wireless data transmission module 202, and a display model 203. The user records a section of a human face video 204 using the camera module 201 of the cell phone 20 and transmits the video 204 with the wireless data transmission module 202 to the network server 21 through the wireless network 22. The network server 21 is provided with a microprocessor 24, a memory 25, and a medium object database 26. The microprocessor 24 reads from the memory 25 and executes a feature recognition program 251 to recognize and position locations of facial features of the human face video 204; the microprocessor 24 reads from the memory 25 and executes a medium object modification program 252 to modify the situation music and parameters of ratios of facial features of a cartoon figure according to those locations of the facial features; the microprocessor 24 follows to read from the memory 25 and executes a video synthesis program 253 to substitute the human face in the human face video 204 with the modified cartoon figure to synthesize residual portions of the human face video 204, the modified cartoon figure, and the situation music into a synthetic video 27; finally, the synthetic video 27 is transmitted back to the cell phone 20 for the user to view the synthetic video 27 through the display module 203.

Furthermore, the synthetic video 27 may be stored in the network server 21. If the network server 21 when turned on is also related to a cell phone server, and a friend of the user makes a call to the user's cell phone for online operation with the user's cell phone through its server, the cell phone server may transmit the synthetic video 27 to the calling cell phone for displaying to achieve the purpose of prompting a video of the caller.

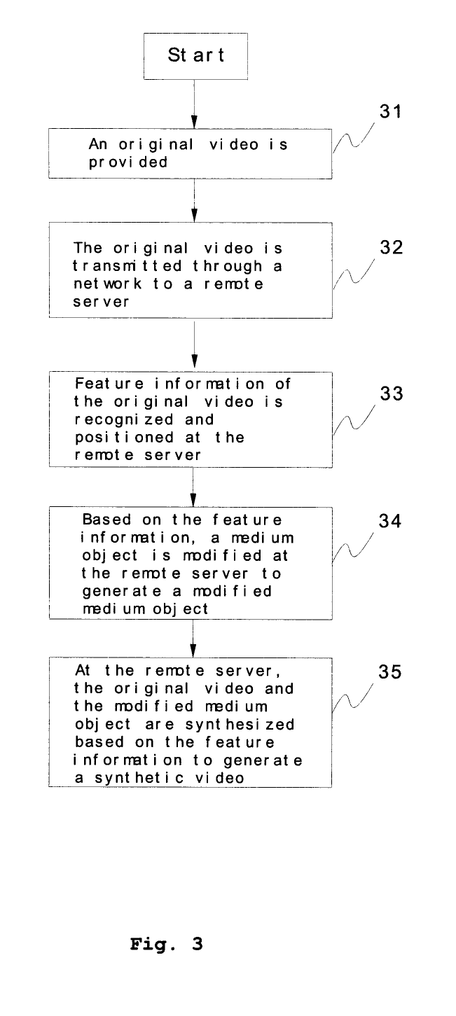

As illustrated in FIG. 3 for a process flow chart of a video generation method of the present invention, the method includes the following steps:

Step 31: an original video is provided;

Step 32: the original video is transmitted through a network to a remote server;

Step 33: feature information of the original video is recognized and positioned at the remote server;

Step 34: based on the feature information, a medium object is modified at the remote server to generate a modified medium object; and

Step 35: at the remote server, the original video and the modified medium object are synthesized based on the feature information to generate a synthetic video.

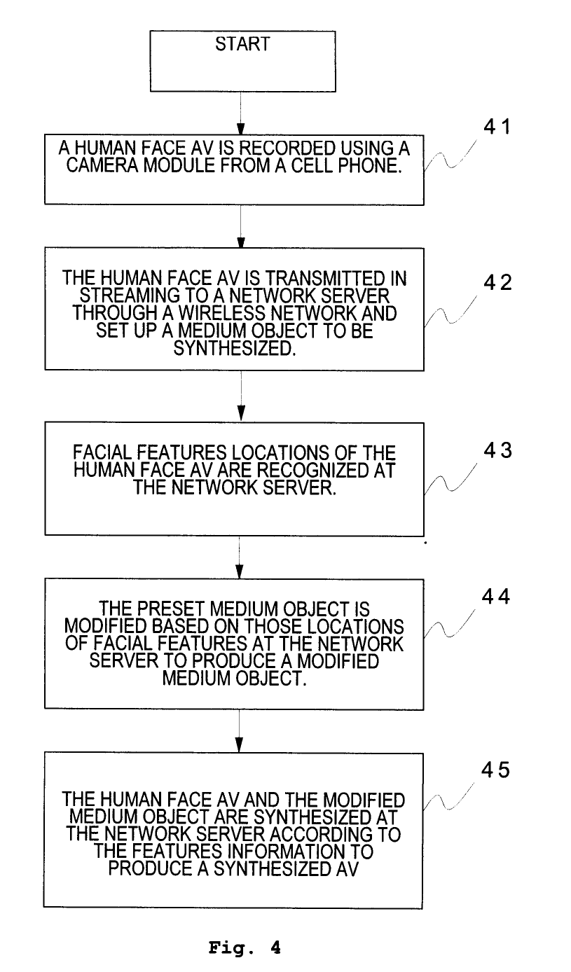

In a preferred embodiment of the video generation method of the present invention as illustrated in FIG. 4, the method includes the following steps:

Step 41: a human face video is recorded using a camera module of a cell phone;

Step 42: the human face video is transmitted using a streaming format to a network server through a wireless network and a medium object to be synthesized is preset;

Step 43: Locations of facial features on the human face video are recognized at the network server;

Step 44: at the network server, the preset medium object is modified to generate a modified medium object according to those locations of facial features recognized; and

Step 45: at the network server, the human face video and the modified medium object are synthesized to produce a synthesized video according to the feature information.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A video generation system includes a network, a camera device to capture an original video and transmit it through the network, and a server being provided with a feature recognition unit, a medium object modification unit, and a video synthesis unit to receive the original video through the network, the feature recognition unit recognizing and positioning feature information of the original video, the medium object modification unit modifying a medium object based on the feature information to produce a modified medium object, the video synthesis unit synthesizing the original video and the modified medium object to produce a synthesized video based on the feature information.

2. The video generation system as claimed in claim 1, wherein the original video is transmitted in a file format or a streaming format.

3. The video generation system as claimed in claim 1, wherein the camera device is adapted to a portable electronic device.

4. The video generation system as claimed in claim 3, wherein the synthesized video is transmitted back to the portable electronic device or stored in the server.

5. The video generation system as claimed in claim 3, wherein the portable electronic device relates to a cell phone, a notebook, a PDA or a digital camera.

6. The video generation system as claimed in claim 1, wherein the original video relates to AV data or a still image.

7. The video generation system as claimed in claim 1, wherein the original video includes image data of a portrait.

8. The video generation system as claimed in claim 7, wherein the feature information includes any combination of features of positions of a facial feature, features and locations of hairs, features and locations of fingers, and postures of trunk and extremities of the image information of the portrait.

9. The video generation system as claimed in claim 1, wherein the medium object relates to a 2D model, a 3D model, audio data or any combination among them.

10. The video generation system as claimed in claim 1, wherein a topic of the medium object is preset by a user.

11. The video generation system as claimed in claim 1, wherein the topic of the medium object is decided by the feature information.

12. The video generation system as claimed in claim 1, wherein the medium object is stored in a database built in the server or a remote database.

13. The video generation system as claimed in claim 1, wherein the network is related to an Internet or a Wireless LAN.

14. A video generation method includes providing an original video; the original video being transmitted through a network to a remote server; feature information of the original video being recognized and positioned in the remote server; a medium object being modified to produce a modified medium object at the remote server based on the feature information; and based on the feature information, the original video and the modified medium object being synthesized at the remote server to produce a synthetic video.

15. The video generation method as claimed in claim 14, wherein the original video is transmitted in a file format or a streaming format.

16. The video generation method as claimed in claim 14, wherein the original video relates to AV data or a still image.

17. The video generation method as claimed in claim 14, wherein the original video contains image information of a portrait.

18. The video generation method as claimed in claim 14, wherein the feature information includes any combination of features of ratios and relative positions of a facial feature, features and locations of hairs, features and locations of fingers, and postures of trunk and extremities of the image information of the portrait.

19. The video generation method as claimed in claim 14, wherein the medium object relates to a 2D model, a 3D model, audio data or any combination among them.

20. The video generation method as claimed in claim 14, wherein the topic of the medium object is preset by a user.

21. The video generation method as claimed in claim 14, wherein the topic of the medium object is decided by the feature information.

22. The video generation method as claimed in claim 14, wherein the medium object is stored in a database built in the server or a remote database.

23. The video generation method as claimed in claim 14, wherein the network is related to an Internet or a Wireless LAN.
